(19) United States
(12) Patent Application Publication
(10) Pub. No.: US 2003/0145012 A1
(43) Pub. Date: Jul. 31, 2003

(54) Shared resource virtual queues

(76) Inventor: Hugh R. Kurth, Lexington, MA (US)

Correspondence Address: BROMBERG & SUNSTEIN LLP, 125 SUMMER STREET, BOSTON, MA, 02110-1618, US

(21) Appl. No.: 10/066,481

(22) Filed: Jan. 31, 2002

(51) Int. Cl. G06F 7/00

(52) U.S. Cl. 707/100

(57) ABSTRACT

A method for sharing buffers among a plurality of queues. A pointer array contains a a linked list of free buffers. Buffers are allocated to a virtual queue by delinking a pointer from the free buffer linked list and adding the pointer to a linked list associated with the queue. When a buffer is no longer needed, the process is reversed.

### TECHNICAL FIELD AND BACKGROUND ART

The present invention relates to methods for accessing information on computer systems and, particularly, to methods for implementing queues.

In computer systems, queues are data structures that contain objects, called “entries,” awaiting processing. A queue where objects are loaded at one end (“the tail”) and taken off in order at the other end (“the head”) is called a first-in-first-out or FIFO queue. A queue where objects are loaded at one end, the head, and taken off from the same end in inverse order of loading is called a last-in-first-out or LIFO queue.

Computer protocols used in contemporary computer systems often require large numbers of queues. The needs of each queue may be dynamic, ranging from requiring no entries to requiring a large number of entries. In prior art computer systems, queues are typically implemented with a large, fixed number of entries. Such an organization may tax the storage capacity of the system.

### SUMMARY OF THE INVENTION

In an embodiment of the present invention, a method is provided for creating queues sharing a common data buffer. A linked list of pointers, called a free pointer list, is created in a pointer array. Each entry in the pointer array is associated with an area in the shared data buffer by a common addressing scheme. The free pointer list has associated with it an entry count, a head pointer and a tail pointer. The head pointer points to the head of the linked list and the tail pointer points to the tail of the linked list. A virtual queue is created by associating an entry count, a tail pointer and a head pointer with the queue. An entry is added to a given queue by first delinking the buffer area pointed to by the free list head pointer and decrementing the free pointer list entry count. The pointer is then added to the given queue by incrementing the given queue's entry count and linking the given pointer to an end of the given queue, either to the head for a LIFO queue or to the tail for a FIFO queue. When a given buffer area is no longer needed by the queue, the entry is dequeued by reversing the process. Embodiments of this invention advantageously allow queues to dynamically grow and shrink according to current storage needs for each queue.

In another embodiment of the invention, a device is provided for managing virtual queues in a computer system. The device includes a shared data buffer and a pointer array. Each entry in the pointer array is associated with an area in the shared data buffer by a common addressing scheme. The pointer array's data elements each point to another entry in the pointer array, forming one or more linked lists. A free list data structure includes an entry count, a head pointer and a tail pointer. Similar data structures are provided for each virtual queue. The device includes logic for deleting an entry from the free list data structure and adding the entry to a given virtual queue data structure. A linked list of pointer entries for the virtual queue is formed. In a further embodiment, the device also includes logic for deleting an entry from a given virtual queue data structure and adding the entry to the free list data structure.

### BRIEF DESCRIPTION OF THE DRAWINGS

The foregoing features of the invention will be more readily understood by reference to the following detailed description, taken with reference to the accompanying drawings, in which:

FIG. 1 is a block diagram for a portion of a computing system according to an embodiment of the invention;

FIG. 2 shows a data structure at initialization containing pointers.

FIG. 3 is a flow chart illustrating initializing data structures according to an embodiment of the invention;

FIG. 4 is a flow chart illustrating a method of adding an entry to a data structure according to an embodiment of the invention; and

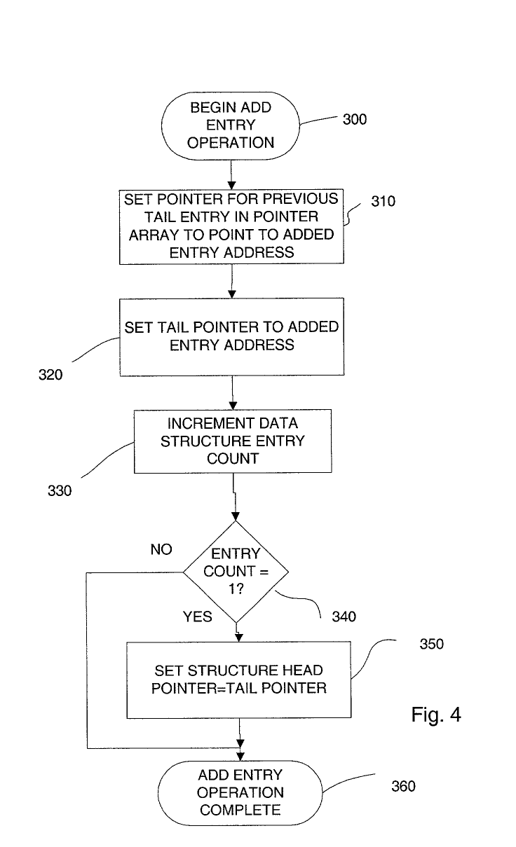

FIG. 5 is a flow chart illustrating deleting an entry from a data structure according to an embodiment of the invention.

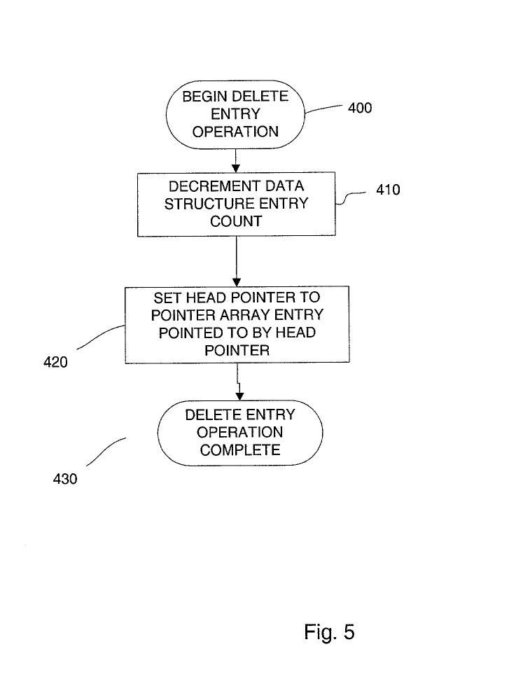

### DETAILED DESCRIPTION OF SPECIFIC EMBODIMENTS

In an embodiment of the present invention, a method is provided for creating queues sharing a common data buffer. A pointer array is provided such that each entry in the pointer array is associated with an area in the shared data buffer by a common addressing scheme. A linked list of pointers, called a free pointer list, is created in the pointer array. The free pointer list has associated with it an entry count, a head pointer and a tail pointer. The head pointer points to the head of the linked list and the tail pointer points to the tail of the linked list. A queue is created by associating an entry count, a tail pointer and a head pointer with the queue. An entry is added to a given queue by first decrementing the free pointer list entry count and then delinking the buffer area pointed to by the free list head pointer. The pointer is then added to the given queue by linking the given pointer to an end of the given queue, either to the head for a LIFO queue or to the tail for a FIFO queue and then incrementing the given queue's entry count. When a given buffer area is no longer needed by the queue, the entry is dequeued by reversing the process. Embodiments of this invention advantageously allow queues to dynamically grow and shrink according to current storage needs for each queue.

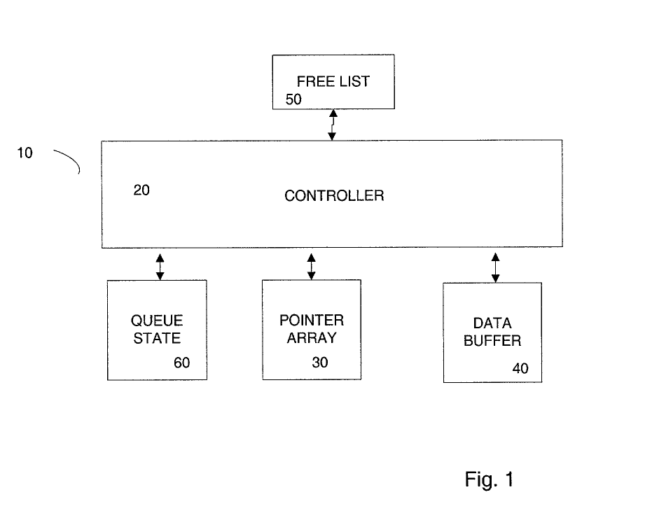

As shown in FIG. 1, a system 10 is provided according to an embodiment of the invention that includes a controller 20 plus several associated data structures. A pointer array 30 includes a linked list of “n” pointers. A data buffer 40 includes a plurality of areas which are addressed in the same fashion as the pointer array. Each pointer in the pointer array is, therefore, associated with an area in the data buffer, the combination of which will be referred to in this specification and any appended claims as an “entry.” A data structure identifying entries that can be allocated to queues, called a “free list” 50, includes three elements: an entry count, a head pointer and a tail pointer. A queue state 60 contains data structures corresponding to a plurality of virtual queues. Like the free list, the virtual queue data structures include three elements: an entry count, a head pointer and a tail pointer.

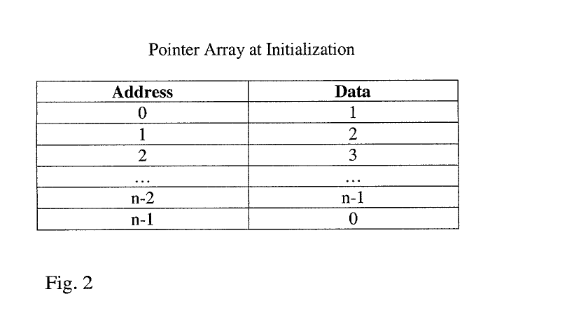

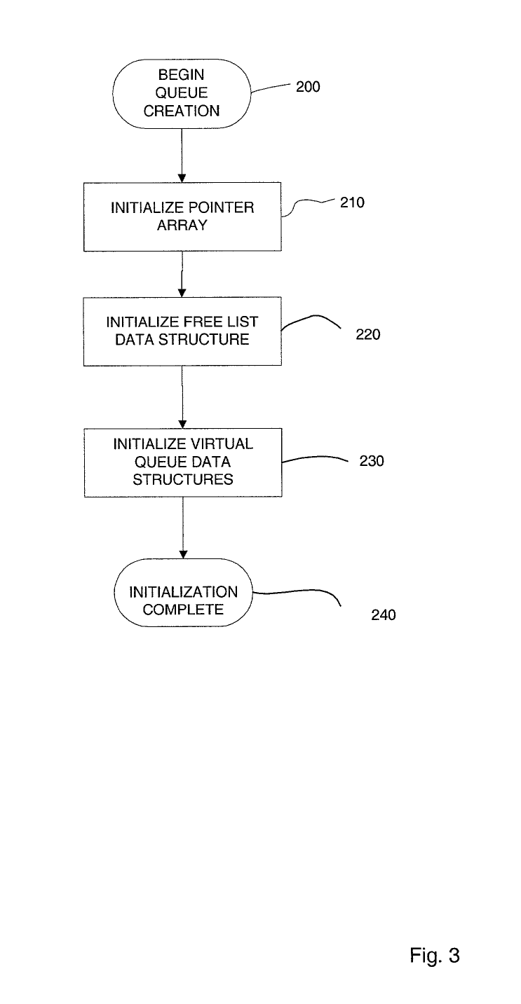

In an embodiment of the invention, a method is provided for creating FIFO queues. As shown in FIG. 3, the data structures are first initialized 200. First, the pointer array 30 is initialized 210, as shown in FIG. 2. Initially all entries are allocated to the free list. The free list is initialized 220 with the entry count set to “n”, the head pointer set to zero and the tail pointer set to “n−1.” The virtual queues are initialized 230 with the entry count for each set to zero.

Entries are added 300 to a virtual queue and to the free list (collectively, “data structures”) in the same fashion. First, the pointer in the pointer array for the entry pointed to by the tail pointer is set 310 to point to the added entry address. Then the tail pointer for the data structure is set 320 to the added entry's address. The entry count is incremented 330. If the entry added is the first entry for the data structure 340, the head pointer is also set 350 to point to this entry 360.

Entries are deleted 400 from a data structure in an analogous fashion. The entry count is decremented 410. The head pointer for the data structure is set 420 to the entry to which the entry deleted from the data structure pointed 430.

An entry is added to a given FIFO virtual queue by first deleting the entry from the free list and then adding the entry to the given virtual queue's data structure. An entry is deleted from the given FIFO queue by first deleting the entry from the given queue's data structure and then adding the entry to the free list data structure. In this way, a common pool of buffer areas can be dynamically shared among a plurality of queues.

In another embodiment of the invention, a method for creating LIFO virtual queues is provided. The method is similar to the method for creating FIFO virtual queues except that entries are added to and deleted from the head of the respective data structure.

Entries are added to a LIFO data structure as follows. If the data structure has one or more entries, the pointer array entry of the entry being added is set to the head pointer for the virtual queue. Then the head pointer for the data structure is set to the added entry's address. The entry count for the data structure is then incremented. If the entry added is the first entry for the data structure, the head pointer is set to the entry added and the tail pointer is also set to point to this entry.

Entries are deleted from a LIFO data structure in an analogous fashion. The entry count is decremented. The head pointer for the data structure is set to the entry to which the entry deleted from the data structure pointed.

An entry is added to a virtual LIFO queue by adding an entry to the virtual queue and deleting the entry from the free list. An entry is deleted from a virtual LIFO queue by deleting the entry from the queue and adding the entry to the free list. This method advantageously allows a plurality of LIFO queues or stacks to be resized dynamically, drawing on a common pool of data buffers.

In a further specific embodiment of the invention, any LIFO data structure may be implemented with an entry count, a head pointer and with no tail pointer: the entry count may be used to avoid attempting to delete entries from the structure when no entries remain.

In a further embodiment of the invention, the free pointer list may be implemented as a LIFO data structure while the virtual queues are implemented as FIFO data structures. Alternatively, the free pointer list may be implemented as a FIFO data structure while the virtual queues are implemented as LIFO data structures.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive.

What is claimed is:

1) A method for creating a plurality of queues using a shared data buffer, the method comprising:
providing a plurality of pointers to the data buffer, each pointer associated with an area of the buffer; and
creating a given queue by associating a given pointer from the plurality of pointers with the given queue.

2) A method according to claim 1, wherein providing a plurality of pointers includes storing the plurality of pointers in a free pointer linked list.

3) A method according to claim 2, wherein associating the given pointer includes removing the given pointer from the free pointer linked list.

4) A method according to claim 3, wherein associating the given pointer further includes storing the pointer in a given queue linked list.

5) A method according to claim 4 further including:
removing the given pointer from the queue linked list and adding the given pointer to the free pointer linked list to delete a member of the given queue.

6) A method according to claim 5, wherein the given queue is a FIFO queue.

7) A method according to claim 5, wherein the given queue is a LIFO queue.

8) A method according to claim 4 wherein the free pointer linked list and the given queue linked list are stored in a given data structure.

9) A computer program product for use on a computer system for managing queues, employing a shared data buffer, the computer program product comprising a computer usable medium having computer readable program code thereon, the computer readable program code including program code for:
providing a plurality of pointers to the data buffer, each pointer associated with an area of the buffer; and
creating a given queue by associating a given pointer from the plurality of pointers with the given queue.

10) A computer program product according to claim 9, wherein providing a plurality of pointers includes storing the plurality of pointers in a free pointer linked list.

11) A computer program product according to claim 10, wherein associating the given pointer includes removing the given pointer from the free pointer linked list.

12) A computer program product according to claim 11, wherein associating the given pointer further includes storing the pointer in a given queue linked list.

13) A computer program product according to claim 12 further including:
removing the given pointer from the queue linked list and adding the given pointer to the free pointer linked list to delete a member of the given queue.

14) A computer program product according to claim 13, wherein the given queue is a FIFO queue.

15) A computer program product according to claim 13, wherein the given queue is a LIFO queue.

16) A computer program product according to claim 12 wherein the free pointer linked list and the given queue link list are stored in a given data structure.

17) A device for managing queues in a computer system, the device comprising:
a shared data buffer;
a pointer array pointing to a plurality of areas of the data buffer;
a free list data structure including an entry count, a head pointer to the data buffer and a tail pointer to the data buffer;
a queue state including a plurality of virtual queue data structures, each queue data structure including a queue entry count, a queue head pointer and a queue tail pointer, the queue head pointer and the queue tail pointer pointing to areas of the data buffer; and
logic for deleting an entry from the free list data structure and adding the entry to a given virtual queue data structure.

18) A device according to claim 17, the device further comprising:
logic for deleting an entry from a given virtual queue data structure and adding the entry to the free list data structure.
